(19) United States
(12) Patent Application Publication
(10) Pub. No.: US 2021/0279792 A1
(43) Pub. Date: Sep. 9, 2021

(54) Electronic idea and collaboration marketplace

(71) Applicant: Moneef B. Bin Break, Philadelphia, PA (US)

(72) Inventor: Moneef B. Bin Break, Philadelphia, PA (US)

(73) Assignee: LAM Innovations LLC, Philadelphia, PA (US)

(21) Appl. No.: 15/929,397

(22) Filed: Apr. 30, 2020

Related U.S. Application Data
(60) Provisional application No. 62/987,046, filed on Mar. 9, 2020.

(51) Int. Cl. G06Q 30/08; G06Q 10/10

(52) U.S. Cl. CPC G06Q 30/08; G06Q 10/103

(57) ABSTRACT

A collaborative idea marketplace system, is disclosed. The system includes a user database, said user database comprising at least two categories of anonymous users including owners and collaborators, wherein said owners are one or more of inventors, designers and/or makers. The system includes an idea database, said idea database including a dynamic database schema describing attributes of an idea owned by an owner of a plurality of owners in said user database. The said dynamic database schema includes attributes including one or more of an idea titles, an image describing or illustrating the idea, an idea description wherein said idea description includes any form of multimedia content, and user interface elements for permitting user actions on said idea.

### FIELD OF THE INVENTION

The present invention is directed generally to development and commercialization of idea submissions. Specifically, the present invention is directed towards a cryptographically assisted commercial network method or system, designed to facilitate idea submission, collaboration, purchase, licensing and/or innovation transfer.

### BACKGROUND

Today's society is dependent upon innovation, technological growth and open source collaboration. The advancement of society depends on various forms of collaboration that allows for some of the greatest minds to come together and develop some of the greatest ideas that stimulate innovation. The protection of these ideas is often an issue that stifles innovation and impedes the abilities of innovators to either provide assistance to other innovators. Various innovators and inventors can benefit from collaborative assistance, and strategic partnerships, especially while developing ideas in the early stages. This is extremely important for innovators lacking a private community to collaborate within, for example a large company research and development department.

In some protective aspects, innovators will pursue patent proception via a filing a respective patent office. However, patents are often valued not directly for their contribution to the value of products and services, but as bargaining chips for defending against others who hold patents. As such, there has been an increasing concern with patent infringers who ignore the claims of inventors who lack the resources to pursue the infringers via a lawsuit. This further discourages many inventors from developing their ideas and from trying to commercialize them.

In other resources, many meaningful inventions and innovations are protected by only providing substantive disclosures of innovations with selective parties under agreements of confidentiality. In many cases, postings are anonymous until a mediated introduction is brokered by the marketplace, and further interactions are often offline and external to the marketplace. Membership may be restricted to highly qualified participants. This limitation of information to superficial functional and marketing descriptions, membership restrictions, and the mediation processes and the complex agreements required to dig deeper can seriously impede idea flow.

As such, there is a long felt need in order to provide a system that will stimulate collaboration. This system will be beneficial as it will provide for a system designed to facilitate idea submission, purchase, licensing and/or innovation transfer.

Accordingly, embodiments of the invention, provide significant advantages while overcoming the above-described and other disadvantages, as will now be described.

### SUMMARY OF THE INVENTION

For the foregoing reasons, there is a need for a system designed to facilitate idea submission, purchase, licensing and/or innovation transfer. The primary object of the invention is to provide for a novel and improved process of electronically commercializing and collaborating with one or more innovators, in a safe, protected, and efficient location.

In some aspects, a collaborative idea marketplace system, is disclosed. The system includes a user database, said user database comprising at least two categories of anonymous users including owners and collaborators, wherein said owners are one or more of inventors, designers and/or makers. The system includes an idea database, said idea database including a dynamic database schema describing attributes of an idea owned by an owner of a plurality of owners in said user database. The said dynamic database schema includes attributes including one or more of an idea titles, an image describing or illustrating the idea, an idea description wherein said idea description includes any form of multimedia content, and user interface elements for permitting user actions on said idea.

The said collaborators of said user database, upon reviewing

attributes of a particular idea, are presented with at least two action options. The said action options including buying or bidding said particular idea or offering to collaborate with an owner of said particular idea. The said action options are succeeded by dynamic business rules. The said business rules define financial terms and/or financial responsibilities as well as legal terms and/or responsibilities.

In one embodiment, the one or more collaborators of said user database, upon reviewing attributes of a particular idea, are presented with at least two action options.

In one embodiment, the action option includes one or more of buying or bidding said particular idea or offering to collaborate with an owner of said particular idea.

In one embodiment, the action options are succeeded by dynamic business rules.

In one embodiment, the dynamic business rules define financial terms and/or financial responsibilities, and legal terms or responsibilities.

In one embodiment, the owners are one or more of inventors, designers and/or makers.

In one embodiment, the idea description includes any form of multimedia content.

In one embodiment, the collaborators are permitted to select from the one or more idea titles to review idea information of the one or more ideas.

In one embodiment, the collaborators are permitted to submit one or more of a collaboration offer or a purchase offer for the one or more idea titles.

In one embodiment, the system can further include sending one or more collaboration offers or one or more purchase offers to the owners, selecting, by an owner, a preferred offer from the one or more collaboration offers or one or more purchase offers from the one or more collaborators, and adding or co-assigning a collaborator to a particular idea.

In one embodiment, the system can further include selecting by, a collaborator of the one or more collaborators, one or more idea titles. The system can also include filling out a particular offer, by the collaborator, comprising one or more of a collaboration offer or a purchase offer for the one or more idea titles. The system can also include submitting the particular offer.

These systems and methods may, according to various embodiments of the present invention, support the creation of ideas an innovation while providing valuable protection of intellectual property, ideas, and inventions in furtherance of development for the public good.

This Summary is provided merely for purposes of summarizing some example embodiments, so as to provide a basic understanding of some aspects of the subject matter described herein.

Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

Disclosed herein are embodiments of apparatuses, methods, and systems pertaining to delivering of packages and products from a shipper to a recipient. This description includes drawings, wherein:

FIG. 1a, FIG. 1b, and FIG. 1c depict a create account page, in accordance with an example;

FIG. 2a, FIG. 2b, and FIG. 2c depict example owner home screens, in accordance with an example;

FIG. 3a, FIG. 3b, and FIG. 3c depict an example submittance form for a new idea, in accordance with an example; and

FIG. 4a, FIG. 4b, and FIG. 4c depict an example proposal screen, in accordance with an embodiment.

Elements in the figures are illustrated for simplicity and clarity and have not been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Some detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

The invention may be embodied in other specific forms without departing from the spirit of essential characteristics thereof. The present embodiments therefore to be considered in all respects as illustrative and not restrictive, the scope of the invention being indicated by the appended claims rather than by the foregoing description, and all changes which come within the meaning and range of equivalency of the claims are therefore intended to be embraced therein.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The following description is not to be taken in a limiting sense, but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The present invention provides for a collaborative idea marketplace system, is disclosed. The system includes a user database, said user database comprising at least two categories of anonymous users including owners and collaborators, wherein said owners are one or more of inventors, designers and/or makers. The system includes an idea database, said idea database including a dynamic database schema describing attributes of an idea owned by an owner of a plurality of owners in said user database. The said dynamic database schema includes attributes including one or more of an idea titles, an image describing or illustrating the idea, an idea description wherein said idea description includes any form of multimedia content, and user interface elements for permitting user actions on said idea.

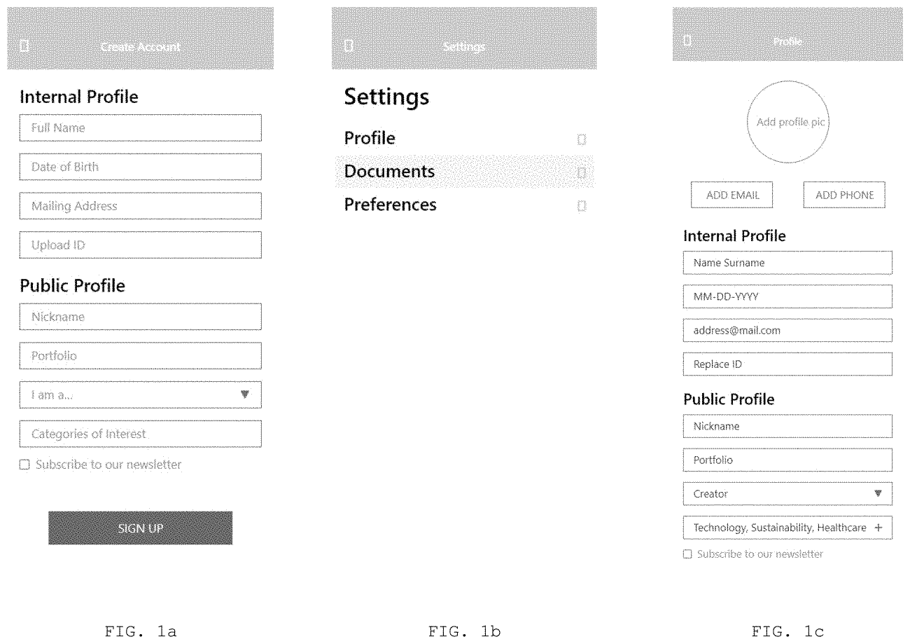

Referring now to FIGS. 1-4, various features for a marketplace system, are discussed.

Turning now to FIGS. 1a-1c, which depicts a create account page, where multiple participants can sign up for the web based or mobile application system. Each of these participants are able to interact and collaborate with each other in order to assist with innovation, invention, idea sharing, or think tanking, in order to facilitate innovative growth. Accordingly, an arbitrarily large population of participants can be connected via the system platform at various times during marketplace activity. In some instances, each of the participants can use one or more participant systems connected to a network, such as the global Internet, a plurality of severs, and a plurality of databases. Accordingly, accessible to each of the participants upon signing up for an account is the marketplace, which may be a complex set of systems as described below.

Also accessible via network may be other marketplaces, and other systems, including systems that may provide services to the participants or to the marketplaces or to other communities. Participants may achieve different levels of qualfications based on their marketplace interactions, or one or more qualifying parameters. Accordingly, these participants based on these qualifying parameters can operate at different levels with corresponding levels of privilege and responsibility. In accordance, multiple marketplaces may cooperate with one another to offer combined services and form combined communities.

These participants can comprise of a plurality of different roles that are closely aligned to owners of an idea, and collaborators who are looking to either purchase the idea, or work with the owner to develop the idea. Additionally, participants can also take on a variety of other roles such as:

1) Idea creators/inventors

2) Assignees

3) Independent raters

4) Advisors/collaborators who may add value and development, but might not be “inventors” for purposes of patent law

5) Commercializers/implementers

6) Users or appliers of ideas and inventions, including manufacturers and services

7) End-users and consumers, including those using an invention or using the end-result of use of an invention

8) Investors and sponsors

9) Support service providers which may be fee oriented

10) Government/regulatory bodies

11) Group roles, such as expert panels and the like

12) Special roles, such as dialog managers or moderators, arbitrators, stewards, or the like

It is noted that each participant may participate in multiple roles. It is further noted that participants may include both individual persons and corporate or other organizational entities, and that such entities may have complex relationships.

Accordingly, each of these participants are able to create an account in the system that can require one or more of a full name, a date of birth, a mailing address, and an upload ID field to verify your identification. Additionally, there can be a public profile section that is viewable by other participants that comprises of a nick name, a portfolio name, gender, occupation, and categories of interest.

There can also be a settings screen, which allows the user to set one or more settings that are tied to their profile, documents, or preferences. For example, the profile settings selection can allow a participant to adjust their profile information for the internal system, and their publicly viewable indication, as desired.

The system as a whole operates as a witness of idea development and ownership. In addition, the system can be operable as an electronic collaboration space and an idea marketplace by time stamping submission, and tracing and transferring ownership.

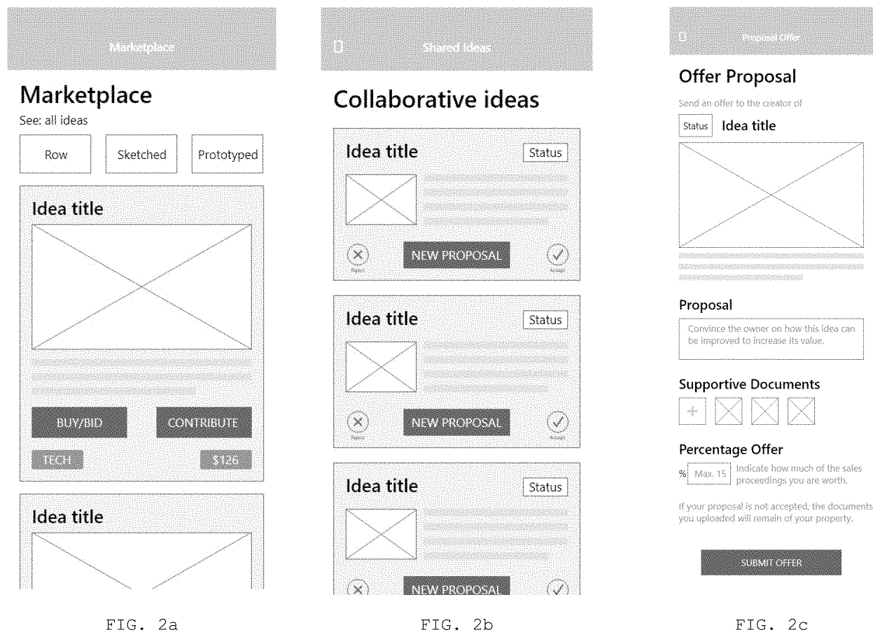

FIGS. 2a-2c depict example owner and collaborator home screens. The marketplace is configured to display a plurality of ideas in their forming stage which can be either row sketched or blueprinted or prototyped. Each idea can include a title of the idea, an image that described or shows the idea, a short description of the idea, and one or more buttons to buy or bid with a current price and bid time, or an offer to collaborate with the owner to take the idea to the next level.

The collaborator can then select one of the one or more idea titles, representing the different ideas that have been submitted by the owners. The selection of an idea allows the collaborator to view the idea details of the idea, and the different stages that the owner has reached in real-time. As such, a full page of all of the ideas, information, photos, uploaded documents, and descriptions are readily available to each collaborator that accesses the idea's details. Each listing of the one or more ideas can be provided by one or more idea titles and an associated image. After the image, an executive summary is displayed, which can be as long as necessary to convince the buyer or collaborator. At the end of the page, a viewer has the option either to buy, bid, or offer to collaborate that take the viewer to an offer form. Upon a collaborator or buyer submitting an offer, the owner of the idea is able to view their offers received from their account platform, in order to select a preferred offer that meets their business needs.

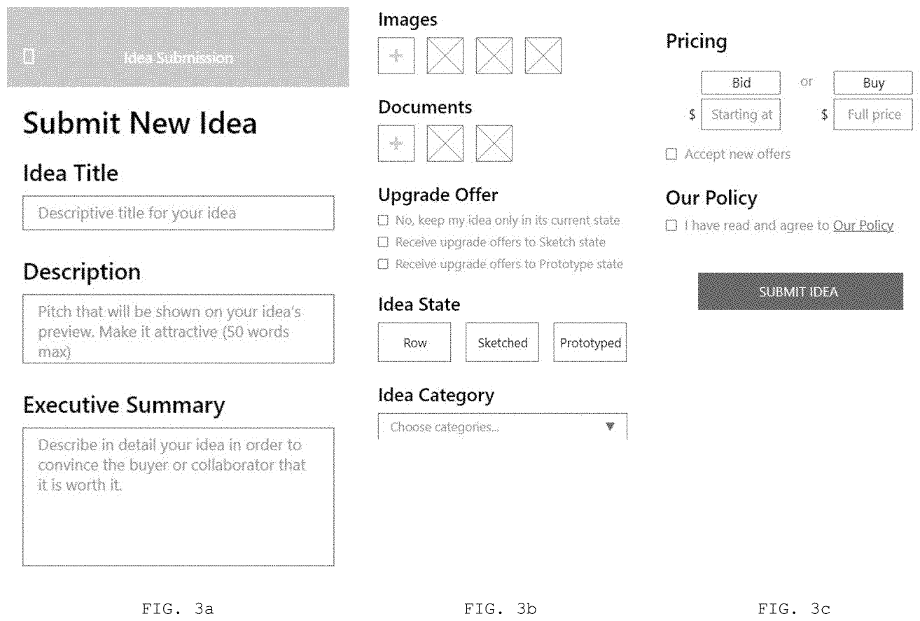

FIGS. 3a-3c depict an example submittance form for a new idea. An Owner is able to submit their idea, or a plurality of ideas to the system platform in order to be viewed by collaborators for purchase or co-collaboration. The screen viewable by the Owner provides for a submit new idea form that comprises of one or more of an idea title, a description or pitch of the idea, an executive summary to convince the buyer or collaborator that investment of time or money is worth it, and one or more images representing the idea. Additionally, the owner can provide a set of offer details that they would be willing to accept. The Owner can provide an upgrade offer indication that can indicate if the owner would like to keep their idea in it's current state, or if the owner was open to upgrading the sketch or the prototype of the idea. The owner can also indicate if the idea state is in a row state, a sketched state, or a prototyped state. The owner can also choose an idea category that will more specifically categorize the idea. These categories can be utilized in a way that will allow collaborators or buyers to more efficiently filter a plurality of ideas, and invest their time or money in area of interest, according to the categories. The owner can also indicate a bid starting price, or a purchase price that would be acceptable. In some instances, the owner could be required to accept one or more platform or system policies.

Based on this submission, the host of the system or platform is providing a legal witnessing way to protect an idea. The interested buyers are considered to be responsible for the literature that they have revised. In an instance where the idea is bought, the responsibility for patent filing, an protection of the idea will then fall on the purchaser. In some instances, a legal partner can be recommended to all of the buyers to receive a free estimate or presentation for legal services. Additionally, once the idea is bought, a sale is required to close within a predetermined period. This period could be automatically set, or selected by the owner. In some embodiments, all of the users can be anonymous in order to protect the identity of the investor or owner, to prevent discrimination of any type.

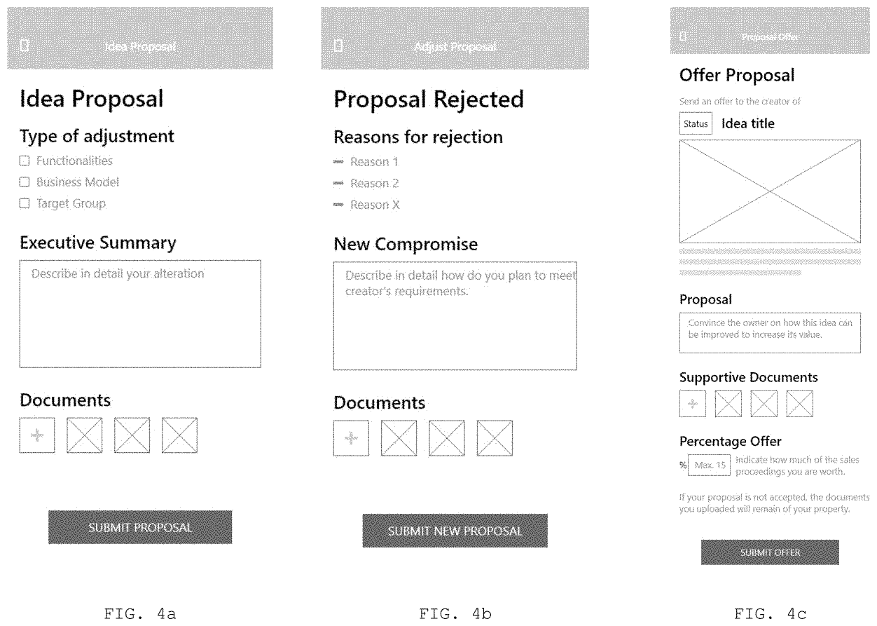

FIGS. 4a-4c depict an example proposal screen, in accordance with an embodiment. The collaborator or buyer can access the proposal offer page or screen if an interest is found in the idea. The proposal can be written in summary to convince the owner of the idea on hos the idea can be improved to increase its value. Accordingly, supportive documents can be provided in order to allow the owner to have documentation that will support the proposal. Additionally, a percentage offer can be provided in order to indicate how much of the sales proceeds the buyer is worth, in order to finalize an equity sale on a scale from 1 percent to 100% equity. The owner can set a minimum percent equity in the settings page of the idea posting.

In another example, an idea proposal can be provided. The idea proposal can indicate a type of adjustment. The type of adjustment can be selected from one or more of functionalities, business model, or target group. In conjunction, the collaborator can provide an executive summary that describes the details that the proposed collaborator would like to alter in order to convince the owner that they would be the best suited collaborator to add to the idea.

In the instance that the proposal is rejected by the owner, the collaborator or buyer can receive a proposal rejected notification. Additionally, an adjust proposal screen can be accessed in order to submit a response to the rejection. In the adjust proposal screen, the reasons for rejection are listed. Additionally, a text field is provided which allows the collaborator or buyer to provide a new compromise which allows them to describe in detail how they plan to meet the owner's requirements, and overcome the reasons for rejection. In addition, supporting documents can be provided for the owner's consideration. Once all of the necessary fields are filled out, the collaborator or owner can submit the new proposal for the owner's review.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

Once a collaboration offer is approved, both the owner and the collaborator can have access to idea's mail page content, and can upload unlimited files to share ideas. Additionally, both owner and collaborators can share contact information for out of service communication. Only documented improvements and additions approved by both owner and collaborator get submitted for the final pitch, which can then be purchased or licensed on one or more other marketplace platforms. Any unapproved documents are configured to remain on the platform, until approved by both parties.

In one embodiment, an owner can access their idea's main page. On the main page, the owner can retrieve all offers, and their associated information. The owner can then accept or pick a preferred offer if from a buyer, or add or co-assign a collaborator to the corresponding idea if from a collaborator.

Although the present invention has been described in terms of various embodiments, it is not intended that the invention be limited to these embodiments. Modification within the spirit of the invention will be apparent to those skilled in the art.

1. A system operable as a collaborative idea marketplace configured with a memory and one or more processors, the system comprising:
a user database stored in the memory of the system, said user database comprising user data for a plurality of users, each of the plurality of users being classified into one or more of at least two categories of anonymous users including owners and collaborators; and
an idea database stored in the memory of the system, said idea database including a plurality of dynamic database schema, each database schema comprising schema data describing attributes of an idea and having associated therewith at least one user from the plurality of users classified as owners in said user database,
wherein the schema data for each dynamic database schema includes attributes including one or more of an idea titles, an image describing or illustrating the idea, an idea description,
and wherein the one or more processors of the system are configured to provide user interface elements for permitting user actions on said the schema data;
and wherein the one or more processors are further configured, in response to an action taken in relation to schema data for a dynamic database schema via a user interface element, to associate a timestamp with the action and record the timestamped action in the system memory.

2. The system of claim 1, wherein the one or more collaborators of said user database, upon reviewing attributes of a particular idea, are presented with at least two action options.

3. The system of claim 2, wherein the action option includes one or more of buying or bidding said particular idea or offering to collaborate with an owner of said particular idea.

4. The system of claim 2, wherein the action options are succeeded by dynamic business rules.

5. The system of claim 4, wherein the dynamic business rules define financial terms and/or financial responsibilities, and legal terms or responsibilities.

6. The system of claim 1, wherein the owners are one or more of inventors, designers and/or makers.

7. The system of claim 1, wherein the idea description includes any form of multimedia content.

8. The system of claim 1, wherein the collaborators are permitted to select from the one or more idea titles to review idea information of the one or more ideas.

9. The system of claim 1, wherein the collaborators are permitted to submit one or more of a collaboration offer or a purchase offer for the one or more idea titles.

10. The system of claim 1, further comprising:
sending one or more collaboration offers or one or more purchase offers to the owners,
selecting, by an owner, a preferred offer from the one or more collaboration offers or one or more purchase offers from the one or more collaborators; and
adding or co-assigning a collaborator to a particular idea.

11. The system of claim 1, further comprising:
selecting by, a collaborator of the one or more collaborators, one or more idea titles;
filling out a particular offer, by the collaborator, comprising one or more of a collaboration offer or a purchase offer for the one or more idea titles; and
submitting the particular offer.
